(19) United States
(12) Patent Application Publication
(10) Pub. No.: US 2013/0191809 A1
(43) Pub. Date: Jul. 25, 2013

(54) GRAPHICAL REPRESENTATION OF AN ORDER OF OPERATIONS

(71) Applicant: ANDREW LOVITT, Redmond, WA (US)

(72) Inventor: ANDREW LOVITT, Redmond, WA (US)

(73) Assignee: Microsoft Corporation, Redmond, WA (US)

(21) Appl. No.: 13/357,623

(22) Filed: Jan. 25, 2012

(51) Int. Cl. G06F 9/44

(52) U.S. Cl. 717/109

(57) ABSTRACT

A graphical representation of the order of operations for a portion of source code is generated and displayed in a source code viewer or editor engine. The graphical representation may be visually displayed simultaneously with the source code in the same window or in a separate window in a number of different formats. The various display formats of the graphical representation may take the form of a line representation, a tree representation, a numeric ordering, color highlighted text, color highlighted operators, and so forth. The graphical representation of the order of operations assists a user viewing the source code to understand the order that operations are performed during execution of the source code.

### BACKGROUND

A computer program executes the operations in an expression in accordance with an order of operations. The order of operations is a set of rules that specify which operators in an expression have precedence over other operators. For example, the mathematical expression 2+3×4 may be evaluated where the addition operator takes precedence over the multiplication operator thereby producing a value of 20 (i.e., (2+3)×4 =20). Alternatively, the same mathematical expression may be evaluated where the multiplication operator takes precedence over the addition operator thereby producing a value of 24 (i.e., 2+(3×4)=24). Without specifying the order of operations, inconsistent results may be generated.

The order of operations is often specified by the grammar of the programming language that the computer program (e.g., application, script, etc.) is written in. Each programming language may evaluate an expression using a different order of operations. The different order of operations may present problems for a user when a user views or edits source code written in an unfamiliar programming language. Additionally, the nuances of the grammar of certain programming languages may be complex thereby making the order operations difficult to ascertain.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Source code is written in a programming language having a language model or grammar that specifies the manner in which operations are executed. In particular, the order of operations specifies the precedence of operators with respect to other operators used in the programming language. A graphical representation of the order of operations is displayed along with the source code to enable a user to understand the order in which operations are executed. This is beneficial during development and maintenance of the source code.

The graphical representation may be visually displayed in a number of different formats. The various display formats of the graphical representation may take the form of a line representation, a tree representation, a numeric ordering, color highlighted text, color highlighted operators, and so forth. The graphical representation may display operations that may be performed in any order without affecting the result. Portions of the graphical representation may be collapsed and/or ghosted with special characters.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates a first exemplary system for generating and displaying a graphical representation of an order of operations.

FIG. 2 illustrates a second exemplary system for generating and displaying a graphical representation of an order of operations.

FIGS. 3A-3F illustrate various embodiments of a graphical representation of an order of operations formatted for sequential execution of the operations.

FIGS. 4A-4J illustrate various embodiments of a graphical representation of an order of operations formatted for parallel and sequential execution of the operations.

FIG. 5 illustrates a graphical representation of an expression where only the operators in the expression are displayed in the graphical representation of the order of operations.

FIG. 6 illustrates selectively ghosting and collapsing parts of the graphical representation of an order of operations.

FIGS. 7A-7C illustrate various embodiments of the placement of a graphical representation of an order of operations on a display.

FIG. 8 illustrates a graphical representation of an order of operations generated dynamically.

FIG. 9 is a flow diagram illustrating an exemplary method for generating a graphical representation of a portion of source code that is displayed.

FIG. 10 is a block diagram illustrating an operating environment.

FIG. 11 is a block diagram illustrating a first exemplary computing device.

FIG. 12 is a block diagram illustrating a second exemplary computing device.

FIG. 13 is a block diagram illustrating an exemplary server.

### DETAILED DESCRIPTION

Various embodiments pertain to the generation and display of a graphical representation of an order of operations of a selected portion of source code. The graphical representation of the order of operations may be visually displayed to assist a user (i.e., developer, programmer, etc.) to more fully understand the execution flow of the selected portion of source code. The graphical representation may be visually displayed simultaneously with the source code in the same window or in a separate window in a number of different formats. The various display formats of the graphical representation may take the form of a line representation, a tree representation, a numeric ordering, color highlighted text, color highlighted operators, and so forth. The graphical representation of the order of operations assists a user viewing the source code to understand the order that operations are performed during execution of the source code. This knowledge may be used by the user to debug, test, and/or edit the source code for an intended purpose.

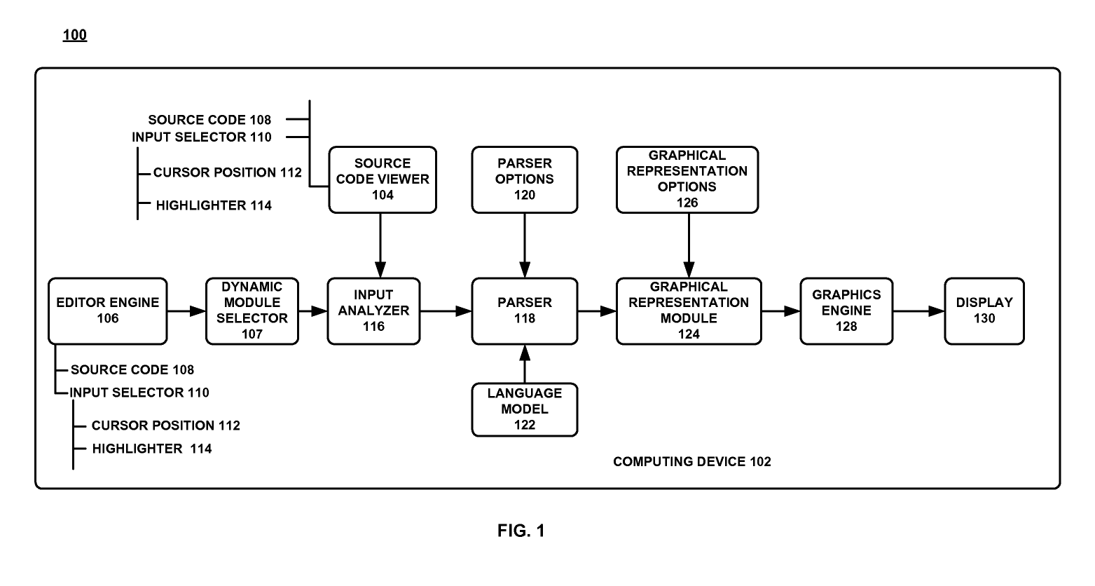

Attention now turns to a discussion of a first exemplary system utilizing a graphical representation of an order of operations. Referring to FIG. 1, there is shown a block diagram of an exemplary system 100 for generating and displaying a graphical representation of order of operations. Although the system 100 as shown in FIG. 1 has a limited number of elements in a certain topology, it may be appreciated that the system 100 may include more or less elements in alternate topologies as desired for a given implementation.

The system 100 may include a computing device 102 that may be any type of electronic device capable of executing programmable instructions such as, without limitation, a mobile device, a personal digital assistant, a mobile computing device, a smart phone, a cellular telephone, a handheld computer, a server, a server array or server farm, a web server, a network server, an Internet server, a work station, a mini-computer, a mainframe computer, a supercomputer, a network appliance, a web appliance, a distributed computing system, multiprocessor systems, or combination thereof.

The computing device 102 may include a source code viewer 104 and an editor engine 106 capable of displaying source code 108. The source code viewer 104 may be a software application that enables a user (e.g., programmer, developer, etc.) to view source code 108. The editor engine 106 may be a software application that is used by a programmer to view, edit, and/or create source code. The source code 108 may be a sequence of computer program instructions, that when executed by a processor, causes the processor to perform methods and/or operations in accordance with a prescribed task. The source code 108 may be a software application, program code, programs, procedures, module, code segments, program stacks, middleware, firmware, methods, routines, web pages, executable code, script files, and so on that may be implemented using any suitable high-level, low-level, object-oriented, visual, compiled and/or interpreted programming language.

A user may select portions of the source code 108 whose order of operations the user wishes to view while the code is being viewed in the source code viewer 104 or editor engine 106. An input selector 110 may be utilized by the user to identify a portion of the source code whose order of operations is of interest. The input selector 110 may be a cursor position 112 and/or a highlighter 114. A cursor position 112 is a position where the cursor is placed that identifies a portion of source code of interest. A highlighter 114 may be a shaded portion of source code that identifies source code of interest. It should be noted that the input selector 110 may be any mechanism that a user may use to identify source code of interest.

An input analyzer 116 receives the portion of the source code the user or program has selected for an order of operations analysis. The input analyzer 116 may also find the entire statement needed for the analysis based on the language model and user options. The input analyzer 116 may receive a statically-selected portion of source code from the source code viewer 104. A statically-selected portion of source code is identified from a static source code listing. The statically-selected portion of source code may be specified through a cursor position, highlighted text, or the like. The input analyzer 116 may recognize that the amount of source code that is specified is not a complete expression or statement, as specified by the language model or user options. In this case, the input analyzer 116 may incorporate additional text or characters into the selected portion of source code to complete the expression or statement.

The input analyzer 116 may also receive a dynamically-selected portion of source code from the dynamic module selector 107. A dynamically-selected portion of source code is identified in real time while the user is generating the source code, testing the source code, and/or editing the source code.

The dynamic module selector 107 determines which portion of source code the user wishes to have its corresponding order of operations displayed. In some cases, the user may identify the portion of source code through highlighted text. In other cases, the dynamic module selector 107 has to determine the portion of source code from an input selector 110 such as a cursor position 112. For example, if the cursor position 112 is placed in the middle of a line of source code, the dynamic module selector 107 determines what characters in the line to include in the portion of the source code so that a completed expression is obtained.

In addition, the dynamic module selector 107 may have to infer the portion of source code that the user is selecting for the order of operations analysis. In a real time editing context, such as with the editor engine, the user may not be finished typing in source code, or making edits even though the user has selected a portion of source code for the order of operations analysis. The portion of the source code that may be selected is not a complete expression or statement in accordance with the language model or user options. In this situation, the dynamic module selector 107 has to infer the actions of the user to determine whether to include additional characters, to wait for the user to continue typing and type in a logical code separator, and so forth.

For example, to illustrate a role of the dynamic module selector 107, consider the following portion of source code.

void cClass::DoSomething(int*a,intb,intc,intd){ (1)

a+=2; (2)

CrashSystem( ) (3)

inte=*a++; (4)

intf=*a|++; (5)

if(e+f>b*c*d) { (6)

OopsDontCrashSystem( ) (7)

In line (5), there is a cursor, “|”, positioned in the middle of the line after the character “a” and before “++”. The dynamic module selector 107 would recognize that there is additional text after this cursor position and include the rest of the text on line (5) in the selected portion of the source code so that the complete expression is included. Thus, the dynamic module selector 107 would determine that the selected portion of source code is “int f=*a++;”. It should be noted that the input analyzer 116 has the same capability to capture additional text and characters into a statically-selected portion of source code as noted in the code example above.

The selected portion of source code may be utilized by a parser 118 to generate a data structure representing the syntactic structure of the selected code portion. The parser 118 utilizes a language model 122 such as the grammar of the programming language that the source code is written in to determine the syntactic structure of the selected code portion. The language model 122 or grammar includes a set of rules that are used to translate a set of tokens into the syntactic structure of the programming language. Inherent in the grammar is the order of operations that are used to evaluate an expression.

The parser 118 may generate a parse tree that represents the syntactic structure of the selected code portion. A parse tree may contain leaf nodes that represent variables and internal nodes that represent the operators that are applied to the variables in an expression. Alternatively, the parser 118 may utilize other data structures to represent the syntactic structure of the selected code portion, such as, without limitation, a hash table, a vector, and so forth.

The parser 118 may receive one or more parser options 120 that are used to customize the order of operations that are used in the graphical representation. For instance, a user may specify through the parser options 120 that the evaluation of function names should not be considered in the order of operations for a selected portion of source code. Likewise, a user may specify through the parser options 120 that a selected portion of source code should not include lines of code containing less than 50 characters. Other user preferences may also be specified through the parser options 120.

The graphical representation module 124 utilizes the parse tree to generate the graphical representation of the order of operations. The graphical representation module 124 may receive graphical representation options 126 that specify the format of the graphical representation that the user desires. For example, the graphical representation options 126 may include a line representation format, a tree representation format, a numerical ordering format, a colored text format, a font-based text format, and so forth. In addition, the graphical representation options 126 may specify the manner in which the format is used to denote precedence. For example, a line representation format has a line place over each operation in a hierarchical order. The precedence of the operations may be specified by the placement of the lines in either a bottom-to-top order where the bottom line denotes the first operation and each line above it is executed in the order shown above the bottom line. Likewise, in a top-to-bottom order, a top line may be specified to denote the first operation and each line below the top line is executed in the order shown below it.

A graphics engine 128 may be utilized to display the graphical representation onto a display 130 for the user. The graphics engine 128 may be a software application that manages rendering objects, such as the graphical representation of the order of operations, into windows onto a display 130. The display 130 is the screen or visual display unit associated with the computing device 102.

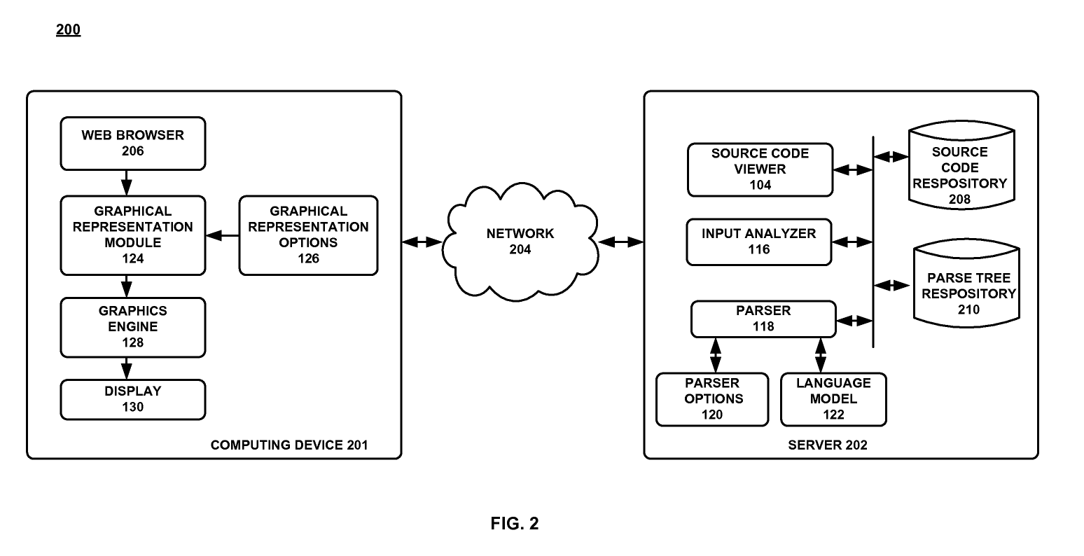

FIG. 2 illustrates a block diagram of a second exemplary system 200 for generating and displaying a graphical representation of order of operations. Although the system 200 as shown in FIG. 2 has a limited number of elements in a certain topology, it may be appreciated that the system 200 may include more or less elements in alternate topologies as desired for a given implementation.

In system 200, a server 202 may be utilized to store volumes of source code that may be viewed by users through a source code viewer 104 that is hosted by the server 202. The user may utilize a web browser 206 from the user's computing device 201 to view the source code through the server's source code viewer 104. When the source code is stored in the server 202, a parser 118 may be used to generate a parse tree or other syntactic representation of the source code which is stored in the server's parse tree repository 210. When a user desires to view the order of operations for a portion of the source code, the web browser 206 may request the corresponding parse tree from the server 202. The server 202 may provide the parse tree to the user's computing device 102 which the graphical representation module 124 may use to generate the order of operations in accordance with the user's graphical representation options 126 onto a display 130.

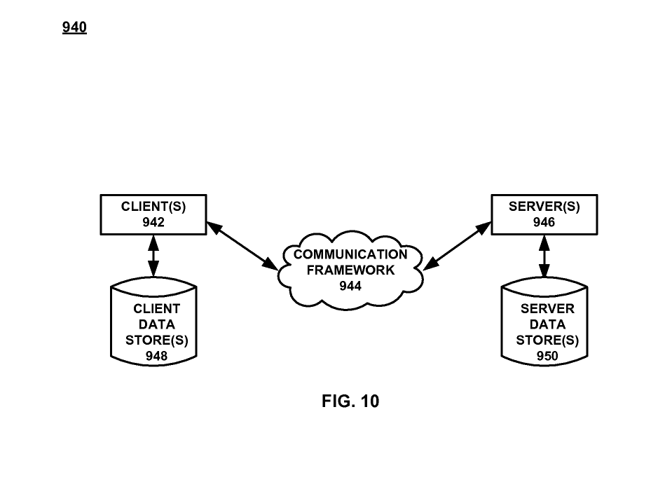

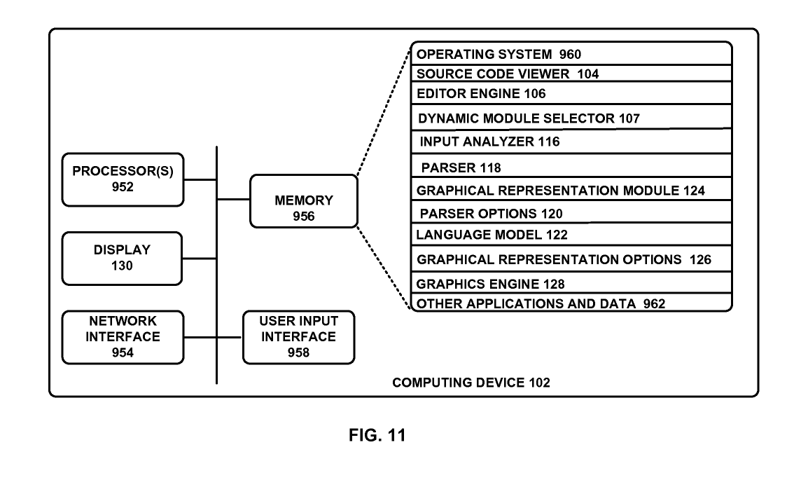

Referring to FIG. 2, the system 200 may include a computing device 201 communicatively coupled to a server 202 through a network 204. The computing device 201 and the server 202 may be any type of electronic device capable of executing programmable instructions such as, without limitation, a mobile device, a personal digital assistant, a mobile computing device, a smart phone, a cellular telephone, a handheld computer, a server, a server array or server farm, a web server, a network server, an Internet server, a work station, a mini-computer, a mainframe computer, a supercomputer, a network appliance, a web appliance, a distributed computing system, multiprocessor systems, or combination thereof. The network 204 may be any type of communications infrastructure that facilitates electronic communication between the computing device 201 and the server 202, and is described in further detail below with respect to the communications framework shown in FIG. 10.

The computing device 201 may include a web browser 206, a graphical representation module 124, graphical representation options 126, a graphics engine 128, and a display. The web browser 206 may be used to view source code hosted on the server 202 through the source code viewer 104. A user may request through the web browser 206 the order of operations for a particular portion of the source code. The parse tree or syntactic representation of the source code may be obtained from the server 202. The graphical representation module 124 may receive the parse tree and generate the corresponding order of operations which is displayed by the graphics engine 128 onto the display 130.

The server 202 may include a source code viewer 104, an input analyzer 116, a parser 118, parser options 120, a language model 122, a source code repository 208, and a parse tree repository 210. Each time source code is uploaded to the server 202 for storage into the source code repository 208, the parser 118 may be activated to generate a parse tree for the source code. The parser options 120 may specify that the parser 118 may regenerate the parse tree when any portion of the source had been modified or at certain times when the source code is stored, viewed, or edited. The embodiments are not limited in this manner.

The parse tree may be stored in the parse tree repository 210. The source code viewer 104 may receive a request for the parse tree associated with a particular portion of the source code which may be retrieved from the parse tree repository 210. The input analyzer 116, parser 118, parser options 120, and language model 122 operate in a similar manner as described above with respect to FIG. 1.

Although the systems 100, 200 shown in FIGS. 1 and 2 have a limited number of elements in a certain configuration, it should be appreciated that the systems 100, 200 can include more or less elements in alternate configurations. For example, the dynamic module selector 107, the input analyzer 116, the parser 118, and/or the graphical representation module 124 may be incorporated into the source code viewer 104, the editor engine 106, an integrated development environment, operating system, cloud service, compiler, cache for a cloud service, email client, operating system, and/or combination thereof. Furthermore, the user may utilize, on the computing device 102, a web editor, web service client, and the like to access the source code hosted on the server 202 shown in FIG. 2.

In other embodiments, the elements of system 200 shown in FIG. 2 may be arranged in alternate configurations. For example, the server 202 may host the editor engine 106 which may be accessed through a web browser 206 or other application residing on the client device 102. In another example, the source code may be stored in the server 202 and viewed through a source code viewer, editor engine, web editor, and the like that resides on the computing device 201. In the case of the editor engine accessing the source code from the computing device, the dynamic module selector 107 may reside in either the computing device 201 or the server 202. In other embodiments, the source code may be stored in the computing device 201 and the parse tree associated with the source code may be stored on the server 202. The computing device 201 may transmit the source code to the server 202, at various times during the development and maintenance of the source code, for the parser, on the server, to generate the associated parse tree. The server 202, in this embodiment, is used to generate, store, and host the parse tree for the use of the computing device 201, when needed.

In various embodiments, the systems 100, 200 described herein may comprise a computer-implemented system having multiple elements, programs, procedures, modules. As used herein, these terms are intended to refer to a computer-related entity, comprising either hardware, a combination of hardware and software, or software. For example, an element may be implemented as a process running on a processor, a hard disk drive, multiple storage drives (of optical and/or magnetic storage medium), an object, an executable, a thread of execution, a program, and/or a computer. By way of illustration, both an application running on a computing device and the computing device may be an element. One or more elements may reside within a process and/or thread of execution, and an element may be localized on one computer and/or distributed between two or more computers as desired for a given implementation. The embodiments are not limited in this manner.

The various elements of systems 100, 200 may be communicatively coupled via various types of communications medium as indicated by various lines or arrows. The elements may coordinate operations between each other. The coordination may involve the uni-directional or bi-directional exchange of information. For instance, the elements may communicate information in the form of signals communicated over the communications medium. The information may be implemented as signals allocated to various signal lines. In such allocations, each message is a signal. Further embodiments, however, may alternatively employ data messages. Such data messages may be sent various connections. Exemplary connections include parallel interfaces, serial interfaces, and bus interfaces.

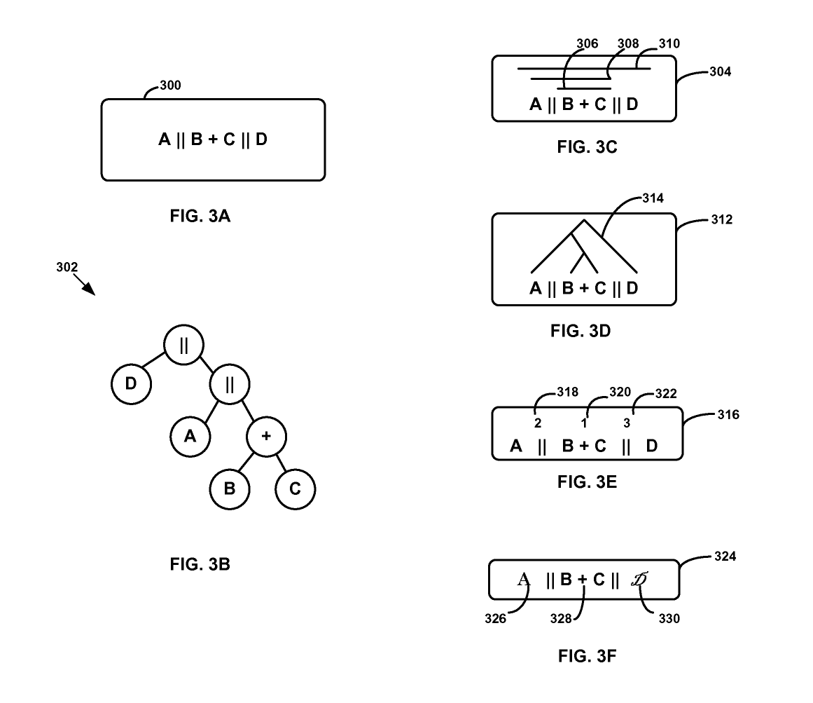

Attention now turns to a further description of the various embodiments of the graphical representations. Referring to FIG. 3A, there is shown a line of source code, written in the C programming language, containing an expression 300 which states A∥B+C∥D. There are four variables in this expression, namely, A, B, C, and D. There are two operators in the expression, namely, the arithmetic add operation ‘+’ and the logical OR operator, “∥”.

FIG. 3B depicts an exemplary representation of a parse tree 302 corresponding to expression 300. The parse tree 302 contains leaf nodes containing the four variables in the expression 300 and the internal nodes contain the operators in expression 300. The order of operations is depicted in the parse tree 302 by traversing the parse tree 302 from the bottom to the top starting from the terminal nodes to the root node. In this manner, the parse tree 302 shows that the order of operations for expression 300 is to compute B+C first, then to compute A∥(B+C), and finally to compute D∥(A∥(B+C)).

The graphical representation of the order of operations for this expression may be represented in any one of the formats shown in FIGS. 3C-3F. For example, referring to FIG. 3C, display box 304 shows a line representation format illustrating the order of operations for expression 300. The line representation format consists of a series of lines displayed in a hierarchical order. The bottom line, which is closest to the expression, denotes that the operation under the line is performed first, followed in succession by each operation associated with the line that precedes it. In particular, line 306 shows that the expression B+C is performed first, line 308 shows that the logical OR operation with A and B+C is performed second (i.e., A∥(B+C)), and line 310 shows that the logical OR operation with D and the expression A∥(B+C) is performed last (i.e., ((A∥(B+C))∥D).

FIG. 3D shows that the order of operations may also be displayed in a tree representation format 314 as depicted in display box 312. The tree representation format 314 depicts a hierarchy of an execution order for the operations in the expression. As shown in display box 312, the operation B+C is performed first, followed by the logical OR operation with variable A (i.e., A∥(B+C)), followed by the logical OR operation with variable B (i.e., ((A∥(B+C))∥D)).

FIG. 3E shows that the order of operations may be displayed in a numeric order format as shown in display box 316. The numeric order format depicts a numeral over each operator that represents the order in which the operator is executed. As shown in display box 316, the operation B+C is performed first as shown by the numeral ‘1’ placed over the “+” operator. The logical OR operation with variable A is performed second (i.e., A∥(B+C)) which is shown by the numeral ‘2’ placed over the logical OR operator “∥” next to variable A. The logical OR operation with variable D is performed third with variable B (i.e., ((A∥(B+C))∥D)) which is shown by the placement of numeral ‘3’ over the logical OR operator “∥” next to variable D.

FIG. 3F shows that the order of operations may be displayed using different colored text or different text font styles to depict the different order of operations. For example, the color red may indicate the first operation, the color blue may represent the second operation to be executed, the color green may represent the third operation, and so on. Alternatively, different font styles may be used to represent the different order of operations. For example, a Times New Roman font may be used to denote the first operation, a Lucinda Handwriting font may be used to denote the second operation, and so forth.

For example, assume an Arial font is used to denote the first operation to be executed, a Century Schoolbook font is used to denote the second operation to be executed, and a Blackadder Script font is used to denote the third operation to be executed. Using these font styles to depict an order of operations in display box 324, the operation B+C is shown to be performed first 326, the logical OR operation with variable A is shown to be performed second (i.e., A∥(B+C)) 328, and the logical OR operation with variable D is shown to be performed third with variable B 330 (i.e., ((A∥(B+C))∥D)).

It should be noted that different colors may be used to denote the order of expressions in lieu of the fonts described above. For example, the text for the expression “B+C” may be displayed in a red color indicating that the operation B+C is performed first. The text for the expression “A∥” may be displayed in a blue color indicating that the logical OR operation with A and B+C is performed second. The text for the expression “∥D” may be displayed in a green color indicating that this operation is performed last. In addition, the coloring of all text, lines, numbers, and so forth can follow a specific pattern specified by the user, the shading of the color, or other pattern that the user specifies in the graphical representation options 126.

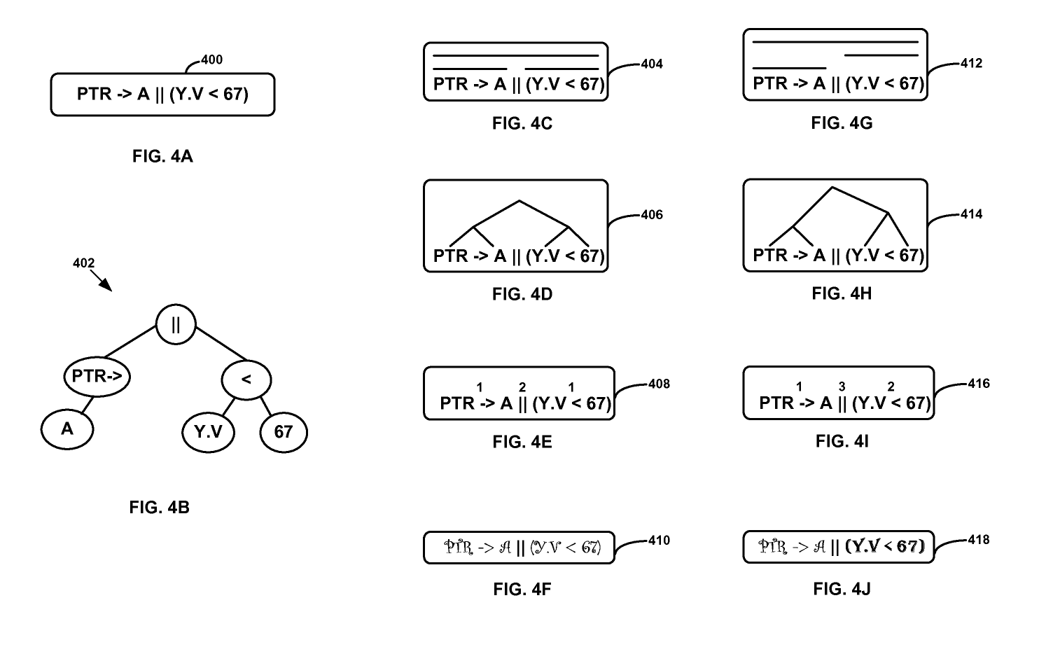

FIGS. 4A-4J illustrate various embodiments of a graphical representation of an order of operations that depicts an expression, written in the C++ programming language, where the operations may be performed in parallel. FIG. 4A shows a Boolean expression 400 that determines whether the logical OR operation applied to the expression (PTR−>A) and (Y.V<67) is 1 or 0. The order of operations may be performed in parallel thereby allowing the graphical representation of the order of operations to be depicted as parallel operations, as shown in FIGS. 4C-4F. FIGS. 4G-4J illustrate the same Boolean expression 400 where the order of operations is depicted in various graphical representations representing serial execution of the same operations.

FIG. 4B depicts the parse tree 402 corresponding to expression 400. The parse tree 402 contains the order of operations for the expression 400 shown in FIG. 4A. In this example, the order of operations for expression 400 is shown by the parse tree 402 which shows that the computation of the Boolean expression (Y.V<67) is performed simultaneously while the Boolean expression (PTR−>A) is evaluated. Next, the logical OR operation of the two values is then computed.

FIG. 4C depicts the line representation format for the expression 400 which shows that PTR−>A and Y.V<67 are logically computed concurrently first followed by the logical OR operation. FIG. 4D shows the tree representation format for the expression 400 and FIG. 4E shows the numeric format for expression 400. FIG. 4F shows the order of operations using different font styles. However, colored text may also be used in lieu of the different font styles shown in FIG. 4F to denote the order of operations. For instance, a red color may be used to display “PTR−>A” and “Y.V<67” which denotes that these operations are performed first. A blue color may be used to display the logical OR operation “∥” indicating that the logical OR operation is performed last.

FIG. 4G depicts the line representation format for the expression 400 which shows that PTR−>A and Y.V<67 are computed in a serial manner in display box 412. FIG. 4H shows the tree representation format for executing the expression 400 serially in display box 414. FIG. 4I shows the numeric format for executing expression 400 serially in display box 416. FIG. 4J shows the order of operations using different font styles in display box 418. However, colored text may also be used in lieu of the different font styles shown in FIG. 4J to denote the order of operations. For instance, a red color may be used to display “PTR−>A” to denote that this operation is performed first and a green color to show that the expression “Y.V<67” is performed second. A blue color may be used to display the logical OR operation “∥” indicating that the logical OR operation is performed last.

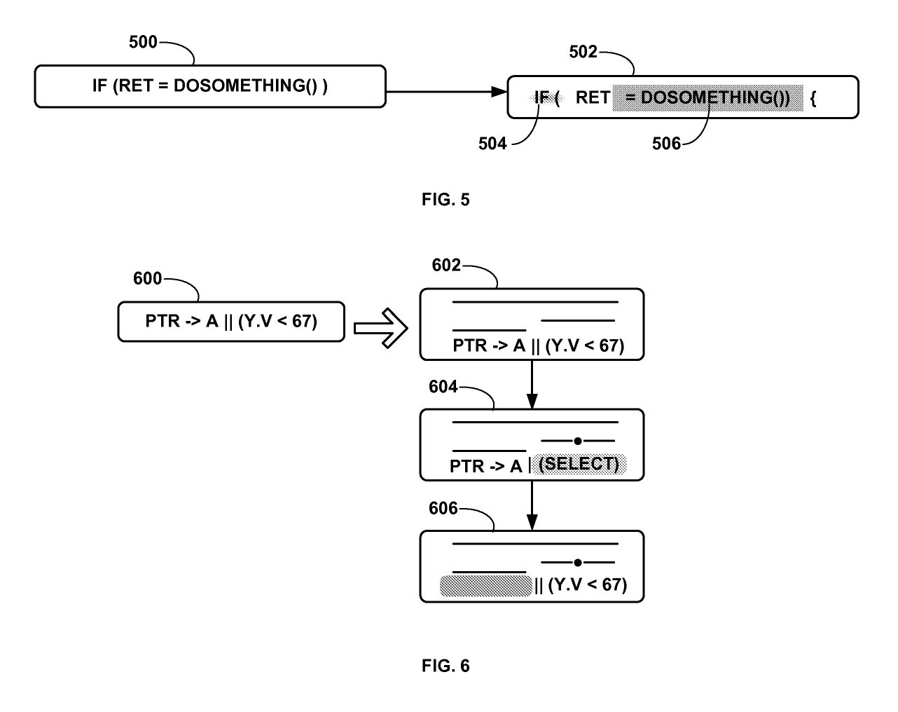

FIG. 5 depicts a graphical representation of an order of operations for an expression where only the operators in the expression are highlighted to represent the order of operations. In the graphical representation shown in FIGS. 3C-3F and 4C-4J, the entire expression was subject to the graphical representation. In FIG. 5, only the operators are graphically represented to depict the order of operations as shown in the graphical representation in display box 502. As shown in FIG. 5, the expression 500 reads IF (RET=DOSOMETHING ( )). The operators in this expression are the function call DOSOMETHING ( ) and the IF statement evaluation. The DOSOMETHING ( ) function call is highlighted in a color or pattern that denotes that the function call is performed first 504 and the IF statement is highlighted in a color or pattern that denotes that the IF statement is evaluated second 506.

FIG. 6 depicts an exemplary illustration of selectively viewing a part of the graphical representation of the order of operations. The selective viewing capability may be utilized by a user when a particular expression needs to be viewed more closely or as the user's preference. In this exemplary illustration, the expression 600 is a Boolean expression PTR−>A∥(Y.V<67). Display box 602 shows the line representation format for the order of operations corresponding to expression 600. Display box 604 shows that a user selected to ghost out the expression (Y.V<67) and to replace the expression with a silly graphic element. In this example, the word “select” replaced the original expression (Y.V<67) and the character “•” was placed over the line representation for the original expression. Display box 604 shows that the expression PTR−>A was collapsed out of the view. The user may initiate ghosting out an expression in the graphical representation through a right mouse click action and may initiate collapsing out an expression through a left mouse click.

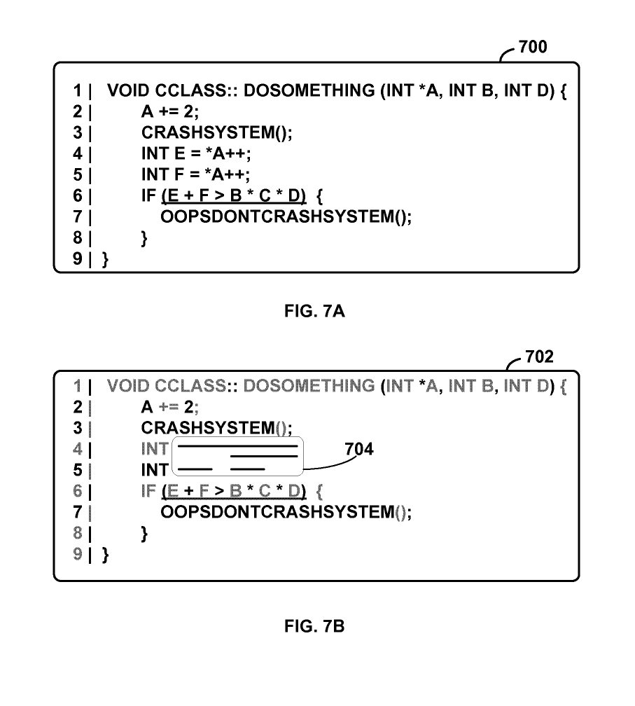

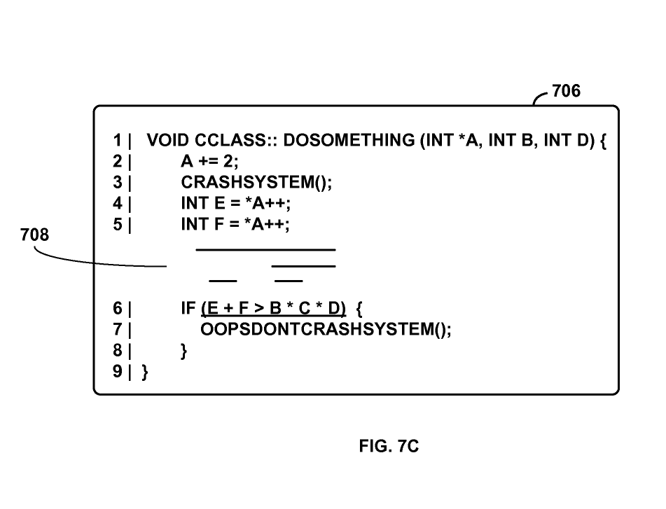

FIGS. 7A-7C depict an exemplary illustration where the graphic representation of the order of operations is placed within the same view as the source code. FIG. 7A shows an exemplary source code listing 702 having nine lines of source code. The expression (E+F>B*C*D) is underlined to show that the user wishes to know the order of operations for this expression. It should be noted that the expression (E+F>B*C*D) may also be highlighted, displayed with colored text, or displayed in any other type of manner to identify the expression.

FIG. 7B shows that a line representation format has been chosen to display the order of operations for the expression. The order of operations is displayed immediately above the expression of interest by overwriting the existing code in lines 4 and 5 as shown by display box 704. Display box 704 may be opaque, partially transparent, or fully transparent. FIG. 7C shows that the line representation format 708 for the expression of interest inserted into blank lines 706 immediately above the selected expression.

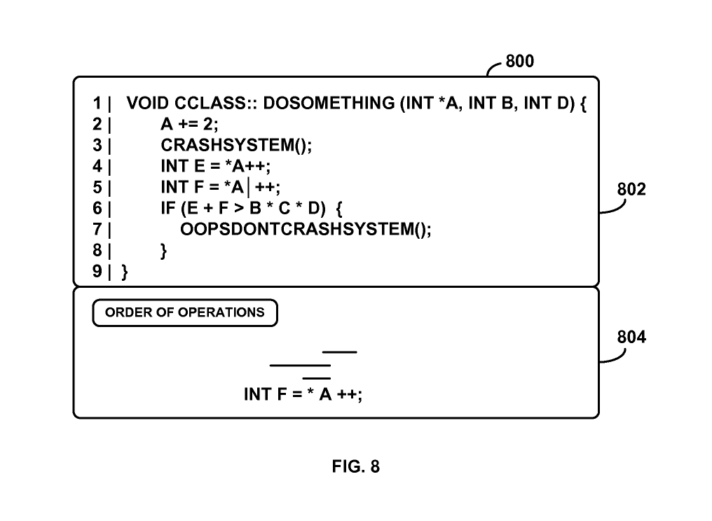

FIG. 8 depicts an exemplary illustration where the graphical representation of the order of operations is displayed in a separate window that is adjacent to the window displaying the source code listing. As shown in FIG. 8, the display 800 consists of a first window 802 that displays a listing of the source code and a second window 804 that displays a graphical representation of the order of operations for a selected portion of the source code shown in the first window 802. A cursor, “|”, is positioned in line 5 between the character ‘A’ and the character ‘+’. The source code in line 5 is selected and displayed as the order of operations in a line representation format in window 804.

Operations for the embodiments may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

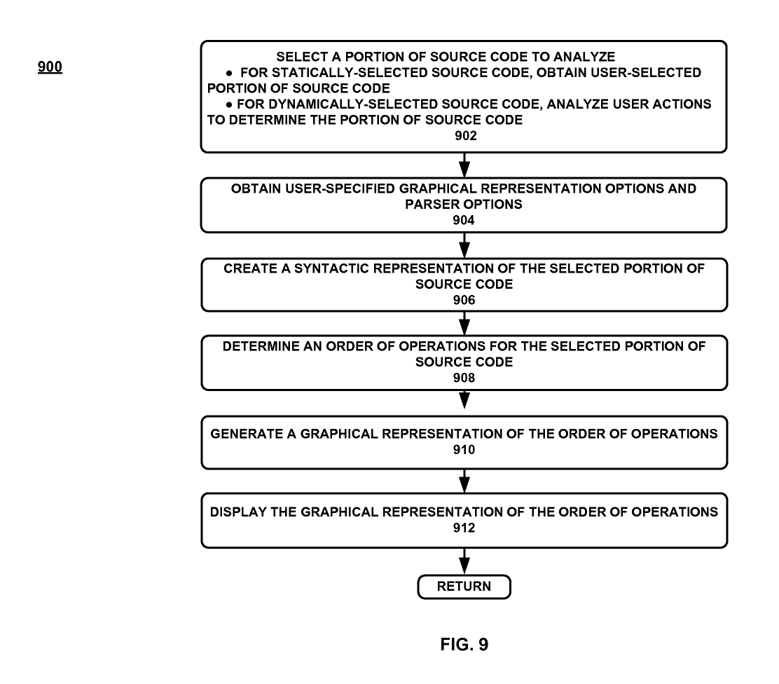

FIG. 9 illustrates a flow diagram of an exemplary method for generating the order of operations. It should be noted that the method 900 may be representative of some or all of the operations executed by one or more embodiments described herein and that the method can include more or less operations than that which is described in FIG. 9.

Referring to FIG. 9, a user selects a portion of source code for analysis (block 902). The source code may be statically-selected through a source code viewer 104, an editor engine 106, or a web browser 206 through an action by a user. The user may utilize an input selector 110, such as a cursor, mouse click, or keystrokes, to highlight or identify a portion of source code. The source code may be dynamically-selected through an editor engine 106 or other software application. In this case, the dynamic module selector 107 may be utilized to track the user's input actions, as the user edits the source code in real time, to determine the portion of source code that the user intends to analyze. The user may utilize an input selector 110 to identify a portion of the source code that the user intends to analyze. However, the dynamic module selector 107 may include additional characters or text into the selected portion of source code in order to complete an operation or to obtain a more meaningful analysis.

A number of options may be specified relating to the graphical representation of the order of operations (block 904). A user may specify parser options 120 and graphical representation options 126. The parser options 120 may indicate certain source code characters, tokens, or statements that the user is not interested in viewing and which the parser 118 may ignore in preparing the parse tree. The graphical representation options 126 may specify the type of graphical representation, such as line representation, tree representation, colored text, etc.

The parser 118 receives the selected portion of source code, the parser options 120, and the language model 122 and generates a syntactic structure representing the selected portion of source code, such as a parse tree (step 906). In one or more embodiments, the parser 118 may be generate the parse tree at designated times, such as when source code is stored in the server 202, when the source code is modified, in whole or in part, or in accordance with settings set in the parser options 120 (step 906).

The graphical representation module 124 receives the parse tree and the graphical representation options 126, determines an order of operations for the selected portion of source code (block 908), and generates a data structure containing the graphic elements and/or commands that the graphics engine 128 uses to display the order of operations in the intended manner (blocks 910 and 912).

Referring to FIG. 10, attention now turns to a discussion of an exemplary operating environment 940. It should be noted that the operating environment 940 is exemplary and is not intended to suggest any limitation as to the functionality of the embodiments. The embodiment may be applied to an operating environment 940 having one or more client(s) 942 in communication through a communications framework 944 with one or more server(s) 946. The operating environment 940 may be configured in a network environment, a distributed environment, a multiprocessor environment, or as a stand-alone computing device having access to remote or local storage devices.

A client 942 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A client 942 may also be embodied as a software module having instructions that execute in a single execution path, multiple concurrent execution paths (e.g., thread, process, etc.), or in any other manner

A server 946 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A server 946 may also be embodied as a software module having instructions that execute in a single execution path, multiple concurrent execution paths (e.g., thread, process, etc.), or in any other manner

The communications framework 944 facilitates communications between the clients 942 and the servers 946. The communications framework 944 may embody any well-known communication techniques, such as techniques suitable for use with packet-switched networks (e.g., public networks such as the Internet, private networks such as enterprise intranet, and so forth), circuit-switched networks (e.g., the public switched telephone network), or a combination of packet-switched networks and circuit-switched networks (with suitable gateways and translators). A client 942 and a server 946 may include various types of standard communication elements designed to be interoperable with the communications framework 944, such as one or more communications interfaces, network interfaces, network interface cards, radios, wireless transmitters/receivers, wired and/or wireless communication media, physical connectors, and so forth. Examples of wired communications media may include a wire, cable, metal leads, printed circuit boards, backplanes, switch fabrics, semiconductor material, twisted-pair wire, coaxial cable, fiber optics, a propagated signal, and so forth. Examples of wireless communications media may include acoustic, radio frequency spectrum, infrared, and other wireless media.

Each client(s) 942 may be coupled to one or more client data store(s) 948 that store information local to the client 942. Each server(s) 946 may be coupled to one or more server data store(s) 950 that store information local to the server 946.

FIG. 11 illustrates a block diagram of an exemplary computing device 102. The computing device 102 may have one or more processors 952, a display 130, a network interface 954, a memory 956, and a user input interface 958. A processor 952 may be any commercially available processor and may include dual microprocessors and multi-processor architectures. The display 130 may be any visual display unit, such as a monitor, screen, touch screen, etc. The network interface 954 facilitates wired or wireless communications with the computing device 102 and other networked devices. The user input interface 958 facilitates communications between the computing device 102 and input devices, such as a keyboard, mouse, etc.

The memory 956 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 956 may also include one or more external storage devices or remotely located storage devices. The memory may 956 contain instructions and data as follows:

an operating system 960;

a source code viewer 104;

an editor engine 106;

a dynamic module selector 107;

an input analyzer 116;

a parser 118;

a graphical representation module 124;

parser options 120;

a language model 122;

graphical representation options 126;

a graphics engine 128; and

various other applications and data 962.

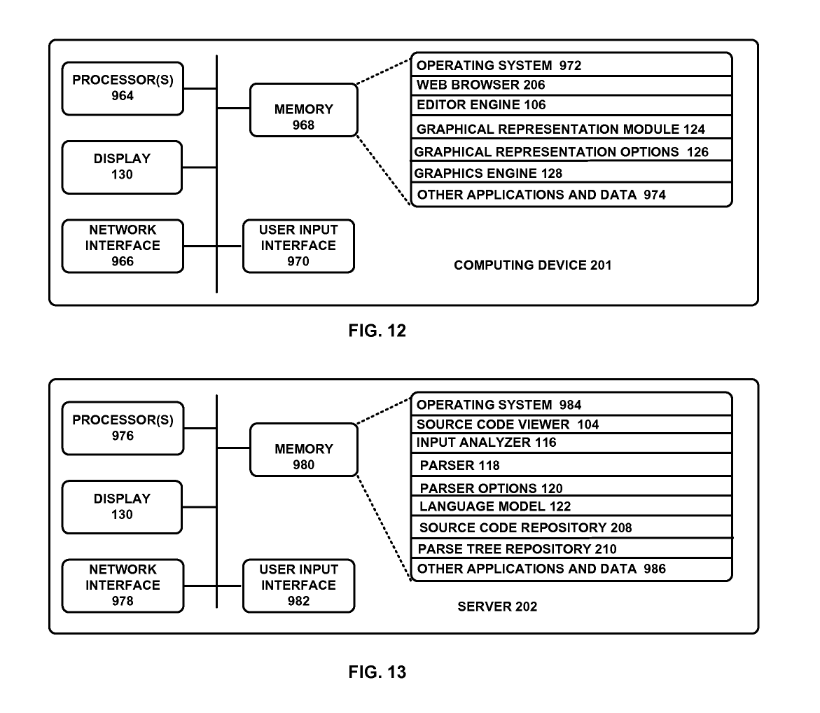

FIG. 12 illustrates a block diagram of an exemplary computing device 201 and FIG. 13 illustrates an exemplary server 202. The computing device 201 may have one or more processors or processing units 964, a display 130, a network interface 966, a memory 968, and a user input interface 970. A processor 964 may be any commercially available processor and may include dual microprocessors and multi-processor architectures. The display 130 may be any visual display unit, such as a monitor, screen, touch screen, etc. The network interface 966 facilitates wired or wireless communications with the computing device 201 and other networked devices. The user input interface 970 facilitates communications between the computing device 201 and input devices, such as a keyboard, mouse, etc.

The memory 968 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 968 may also include one or more external storage devices or remotely located storage devices. The memory may 968 contain instructions and data as follows:

an operating system 972;

web browser 206;

editor engine 106;

a graphical representation module 124;

graphical representation options 126;

a graphics engine 128; and

various other applications and data 974.

The server 202 may have one or more processors or processing units 976, a display 130, a network interface 978, a memory 980, and a user input interface 982. A processor 976 may be any commercially available processor and may include dual microprocessors and multi-processor architectures. The display 130 may be any visual display unit, such as a monitor, screen, touch screen, etc. The network interface 978 facilitates wired or wireless communications between the server 202 and other networked devices. The user input interface 982 facilitates communications between the server 202 and input devices, such as a keyboard, mouse, etc.

The memory 980 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 980 may also include one or more external storage devices or remotely located storage devices. The memory may 980 contain instructions and data as follows:

an operating system 984;

source code viewer 104;

an input analyzer 116;

a parser 118;

parser options 120;

a language model 122;

a source code repository 208;

a parse tree repository 210; and

various other applications and data 986.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

Some embodiments may comprise a storage medium to store instructions or logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as programs, procedures, module, applications, code segments, program stacks, middleware, firmware, methods, routines, and so on. In an embodiment, for example, a computer-readable storage medium may store executable computer program instructions that, when executed by a processor, cause the processor to perform methods and/or operations in accordance with the described embodiments. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

What is claimed:

1. A computer-implemented method, comprising:
selecting a first code portion from a computer program, the code portion having one or more lines of source code;
determining an order of operations for execution of the first code portion, the order of operations based on a language model associated with the source code;
providing a graphical representation for the order of operations; and
displaying the order of operations in accordance with the graphical representation.

2. The computer-implemented method of claim 1, further comprising:
viewing the order of operations in a source code viewer.

3. The computer-implemented method of claim 1, further comprising:
viewing the order of operations in an editor engine.

4. The computer-implemented method of claim 1, further comprising:
specifying a graphical representation to display the order of operations in a line representation format.

5. The computer-implemented method of claim 1, further comprising:
specifying a graphical representation to display the order of operations in a tree representation format.

6. The computer-implemented method of claim 1, further comprising:
specifying a graphical representation to display the order of operations in a colored text representation format.

7. The computer-implemented method of claim 1, further comprising:
specifying a graphical representation to display the order of operations in a numerical order representation format.

8. The computer-implemented method of claim 1, further comprising:
specifying a graphical representation to display the order of operations in a parallel representation format.

9. The computer-implemented method of claim 1, the selecting step further comprising:
designating the first code portion through use of an input selector.

10. The computer-implemented method of claim 1, further comprising:
specifying a graphical representation to display the order of operations within a same visual display window where the first code portion is displayed.

11. The computer-implemented method of claim 1, further comprising:
specifying a graphical representation to display the order of operations within a different visual display window from where the first code portion is displayed.

12. A computer-readable storage medium storing thereon processor-executable instructions, comprising:
instructions that when executed on a processor generates a graphical representation of an order of operations for a selected portion of source code that is visually displayed, the order of operations representing a sequenced order for executing operations in the selected portion of source code; and
instructions that when executed on a processor displays the graphical representation of the order of operations with the visually displayed selected portion of source code.

13. The computer-readable storage medium of claim 12, further comprising:
instructions that when executed on a processor displays the graphical representation of the order of operations inline with the selected portion of the source code displayed.

14. The computer-readable storage medium of claim 12, further comprising:
instructions that when executed on a processor displays the graphical representation of the order of operations in a separate window from the visually displayed selected portion of the source code.

15. The computer-readable storage medium of claim 12, further comprising:
instructions that when executed on a processor selectively enables a portion of the graphical representation of the order of operations to be replaced with a ghosted graphic element.

16. The computer-readable storage medium of claim 12, further comprising:
instructions that when executed on a processor selectively enables a portion of the graphical representation of the order of operations to be collapsed and not visually displayed.

17. A computer-implemented system, comprising:
at least one server, the server having at least one processor and a first memory, the first memory containing a parse tree repository, the parse tree repository containing one or more parse trees;
one or more client devices, a client device having at least one processing unit and a second memory, the second memory containing instructions that when executed on a processing unit:
generates a graphical representation of an order of operations for a selected portion of source code from a parse tree, obtained from the server, the order of operations representing a sequential order for executing operations in the selected portion of source code, and
displays the graphical representation of the order of operations with a visually displayed selected portion of source code.

18. The computer-implemented system of claim 17, the server further comprising a source code repository for storing source code that may be accessed by a client device.

19. The computer-implemented system of claim 18, the server having instructions that when executed on the first processor, generates a parse tree for source code transmitted to the server.

20. The computer-implemented system of claim 19, the server having instructions that when executed on the first processor, transmits a parse tree to a client device upon request from the client device.
